(19) United States
(12) Patent Application Publication
(10) Pub. No.: US 2026/0357938 A1
(43) Pub. Date: Nov. 12, 2026

(54) PIPE JOINT STRUCTURE AND ASSEMBLING METHOD THEREFOR

(71) Applicant: TOYODA GOSEI CO., LTD., Kiyosu-shi (JP)

(72) Inventors: Yuki HAYASHI, Kiyosu-shi (JP); Kenta KUWAYAMA, Kiyosu-shi (JP); Maki TAKEUCHI, Kiyosu-shi (JP); Aya KONDO, Kiyosu-shi (JP); Ryota MIZUTANI, Kiyosu-shi (JP); Masayuki MIYAMURA, Kiyosu-shi (JP)

(21) Appl. No.: 19/646,358

(22) Filed: Apr. 13, 2026

(30) Foreign Application Priority Data
May 7, 2025 (JP) 2025-077608

(51) Int. Cl. F16L 37/252; F16L 41/08

(52) U.S. Cl. CPC F16L 37/252; F16L 41/08

(57) ABSTRACT

Assembling of a pipe joint to a plate member simply at low cost is achieved. A pipe joint structure includes first and second pipe members each having a pipe part and a flange part, and a plate member having a through hole and fixing the first and second pipe members by being sandwiched between both the flange parts in a state where the pipe parts are coupled together. The first pipe member has three claws protruding radially outward at portions located on the front side relative to an opposing surface portion of the flange part opposing a rear surface of the plate member. The pipe joint structure includes a fitting structure for fitting the second pipe member to the first pipe member from the front side of the plate member in a restricted state where the three claws oppose the front surface of the plate member.

### TECHNICAL FIELD

The present disclosure relates to a pipe joint structure for fixing two pipe members to a plate member to couple pipe parts of the pipe members to each other, and an assembling method therefor.

### BACKGROUND ART

Hitherto, a vehicular battery pack installed in an automobile such as an electric vehicle has been known (e.g., JP2023-526828(A)). A battery pack is obtained by connecting a plurality of single cells of a secondary battery such as a lithium-ion battery, a lithium-polymer battery, a nickel-cadmium battery, a nickel-metal hydride battery, or a nickel-zinc battery in series or in parallel, and then accommodating a resultant battery module in a case. A battery installed in an automobile is placed in a harsh use environment and exposed to high-temperature outside air. In addition, in such a case where the battery is used as a power generation source for the automobile, charging and discharging are repeated, and thus, the temperature of the battery tends to be high.

Therefore, the aforementioned battery pack according to JP2023-526828(A) is provided with a pipe for supplying a coolant into the case from outside and cooling the battery through heat exchange. The pipe includes, in addition to an inner pipe routed in the case accommodating the battery module, a pipe joint that is attached to a plate member of the case, and connects together the inner pipe and an outer pipe that is provided outside the case on the supply source side.

The pipe joint has a pipe part extending in a tubular shape, and a flange part connected to the outer circumferential surface of the pipe part and extending radially outward of the pipe part. The plate member of the case is provided with a case through hole into which the pipe part of the pipe joint is inserted. The pipe joint is disposed such that the pipe part penetrates the case through hole and the flange part opposes the plate member via a seal member for ensuring the sealing performance at the case through hole. A plurality of bolt holes are formed in each of the flange part and the plate member. Bolts are inserted into the bolt holes of the flange part and the bolt holes of the plate member, and are fastened with nuts, whereby the pipe joint is attached and fixed to the plate member in a state where the sealing performance is ensured by the seal member.

### SUMMARY

### Technical Problem

However, since the technique in which the pipe joint and the plate member are fixed together by using bolts as described above requires use of bolts provided separately from the pipe joint and the plate member, the number of components increases and assembling the pipe joint to the plate member requires effort. Therefore, the man-hours for assembling the pipe joint and the plate member to each other increase and the manufacturing costs increase.

The present disclosure has been made in view of the aforementioned circumstances. An object of the present disclosure is to provide a pipe joint structure that achieves assembling of a pipe joint to a plate member in a simple manner and at low cost.

### Solution to Problem

One aspect of the present disclosure is directed to a pipe joint structure including:
a first pipe member having a first pipe part through which a fluid flows, and a first flange part connected to an outer circumferential surface of the first pipe part and extending radially outward of the first pipe part;
a second pipe member having a second pipe part which is coupled to the first pipe part and through which the fluid flows, and a second flange part connected to an outer circumferential surface of the second pipe part and extending radially outward of the second pipe part; and
a plate member configured to have a through hole for coupling the first pipe part and the second pipe part to each other, and fix together the first pipe member and the second pipe member by being sandwiched between the first flange part and the second flange part in a state where the first pipe part and the second pipe part are coupled to each other, wherein
the first flange part has an opposing surface portion opposing a rear surface of the plate member,
the first pipe member has a claw protruding radially outward of the first pipe part at a portion located on a front side of the plate member relative to the opposing surface portion,
three or more of the claws are provided so as to be spaced from each other around an outer circumference of the first pipe part,
the first pipe member and the plate member are formed such that
the three or more claws pass through the through hole from a rear side to the front side of the plate member,
the first pipe member is slidingly moved with respect to the plate member in a predetermined direction along an in-plane direction of the plate member, from a post-passing state where the three or more claws are positioned on the front side relative to the plate member, and
the three or more claws oppose a front surface of the plate member in a post-movement state where the first pipe member has been slidingly moved with respect to the plate member in the predetermined direction from the post-passing state to restrict movement of the three or more claws from the front side to the rear side of the plate member, and
the pipe joint structure further includes a fitting structure configured to fit the second pipe member to the first pipe member from the front side of the plate member in a restricted state where the three or more claws are restricted from moving from the front side to the rear side of the plate member.

With this configuration, assembling of the pipe joint to the plate member is achieved in a simple manner and at low cost.

### BRIEF DESCRIPTION OF DRAWINGS

FIG. 1 is a perspective view of a battery pack including a pipe joint structure according to an embodiment of the present disclosure;

FIG. 2 is an exploded perspective view of the pipe joint structure of the present embodiment, as seen from the outer side of a case;

FIG. 3 is an exploded perspective view of a first pipe member and a second pipe member included in the pipe joint structure (O-rings, a spacer, and a gasket are further included) of the present embodiment, as seen from the inner side of the case;

FIG. 4 is a front view, as seen from the outer side of the case, illustrating a state before the first pipe member and the plate member included in the pipe joint structure of the present embodiment are assembled to each other;

FIG. 5 is a front view, as seen from the outer side of the case, illustrating a state after the first pipe member and the plate member included in the pipe joint structure of the present embodiment are assembled to each other;

FIG. 6 is a perspective view of a second pipe assembly including the second pipe member, the O-rings, the spacer, and the gasket provided in the pipe joint structure of the present embodiment;

FIG. 7 is a cross-sectional view of the second pipe assembly shown in FIG. 6;

FIG. 8 is a front view, as seen from the outer side of the case, illustrating states before and after the first pipe member is assembled to the plate member in the pipe joint structure of the present embodiment;

FIG. 9 is a cross-sectional view along a line IX-IX shown in FIG. 8;

FIG. 10 is a perspective view, as seen from the inner side of the case, illustrating a state immediately before the second pipe member is assembled to the first pipe member having been assembled to the plate member in the pipe joint structure of the present embodiment;

FIG. 11 is a perspective view, as seen from the inner side of the case, illustrating a state where the second pipe member is inserted into the first pipe member in the front-rear direction for assembling the second pipe member to the first pipe member in the pipe joint structure of the present embodiment;

FIG. 12 is an enlarged view of a main part in FIG. 11;

FIG. 13 is a rear view, as seen from the inner side of the case, illustrating a state where the second pipe member is rotated with respect to the first pipe member after the second pipe member is inserted into the first pipe member to assemble the second pipe member to the first pipe member in the pipe joint structure of the present embodiment;

FIG. 14 is a cross-sectional view along a line XIV-XIV shown in FIG. 13;

FIG. 15 is a perspective view, as seen from the inner side of the case, illustrating a state shown in FIG. 13;

FIG. 16 is an enlarged view of a main part in FIG. 15;

FIG. 17 illustrates a technique of rotating the second pipe member with respect to the first pipe member by using a wrench tool in the pipe joint structure of the present embodiment;

FIG. 18 illustrates a technique of rotating the second pipe member with respect to the first pipe member by using an automated robot in the pipe joint structure of the present embodiment; and

FIG. 19 is a perspective view, as seen from the inner side of the case, illustrating a state where the second pipe member is rotated with respect to the first pipe member after the second pipe member is inserted into the first pipe member to assemble the second pipe member to the first pipe member in a pipe joint structure according to a modification of the present disclosure.

### DESCRIPTION OF EMBODIMENTS

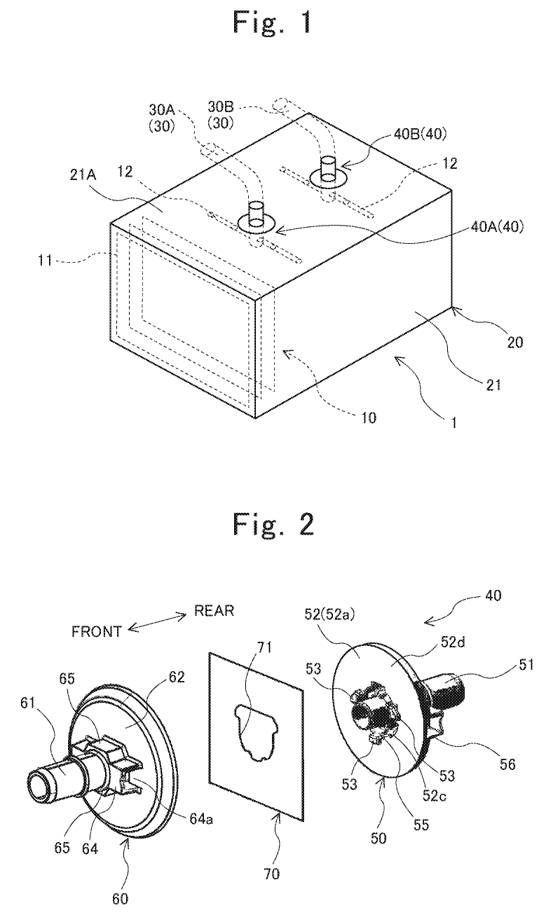

Hereinafter, a specific embodiment of a pipe joint structure according to the present disclosure will be described with reference to FIGS. 1 - FIG. 19. In the present embodiment, "in", "out", "rear", and "front" are defined relative to a case having a plate member, and "in" and "rear" mean the inner side of the case and "out" and "front" mean the outer side of the case. A direction that is orthogonal or substantially orthogonal to a wall surface of the case and connects the inner and outer sides is referred to as a front-rear direction. The right-left direction is defined relative to the case as seen from the outer side of the case.

A pipe joint structure 40 of the present embodiment is a structure for connecting an inner pipe and an outer pipe with a plate member interposed therebetween. The pipe joint structure 40 is preferably applied to a system that causes a fluid such as water, a coolant, hot water, and oil to flow through the inner pipe and the outer pipe with the plate member interposed therebetween. For example, the pipe joint structure 40 is applied to a system that circulates a cooling or heating fluid for a battery pack 1 or the like installed in an automobile or household electric power storage equipment, or a system that supplies a fluid such as water for spraying.

Hereinafter, in the present embodiment, the pipe joint structure 40 is applied to the battery pack 1. The automobile in which the battery pack 1 is installed may be an electric vehicle, a hybrid vehicle, a plug-in hybrid vehicle, or the like, for example. When the battery pack 1 is installed in an automobile, the battery pack 1 suitably includes a battery that serves as a power source during travel of the automobile.

As shown in FIG. 1, the battery pack 1 includes a battery module 10 and a case 20, and further includes the pipe joint structure 40.

The battery module 10 is a device that generates electric power. The battery module 10 has a battery cell 11 which is the minimum unit forming a battery. The battery cell 11 is a secondary battery such as a lithium-ion battery cell, a nickel-metal hydride battery cell, a nickel-cadmium battery cell, and an all-solid-state battery cell, and is formed as a laminate type, a columnar type, or a prism type, for example. The battery module 10 is a module obtained by connecting a plurality of the battery cells 11 in series or in parallel.

The battery module 10 is accommodated in the case 20. The case 20 is a box-shaped member surrounded by six wall bodies 21, and is formed in a rectangular parallelepiped shape, for example. The case 20 is made of a metal such as aluminum, for example. Each wall body 21 is formed in a flat plate shape. A pipe connection wall body 21A connected to a pipe through which a fluid flows is included in the six wall bodies 21. Specifically, the fluid flowing through the pipe is water or a coolant for cooling the battery cells 11 in the case 20, hot water for warming the battery cells 11, or the like.

As shown in FIG. 1, the pipe connection wall body 21A may be the upper wall, for example, and may be a side wall or the bottom wall. In addition, the pipe connection wall body 21A may be one of the six wall bodies 21, and may be two or more of the six wall bodies 21.

The battery module 10 has an inner pipe unit 12. The inner pipe unit 12 is a pipe unit for cooling or warming the battery cells 11. The inner pipe unit 12 has an inner channel connecting an inlet through which the fluid flows in and an outlet through which the fluid flows out. Preferably, the inner channel of the inner pipe unit 12 is evenly routed in the case 20, and preferably, the battery cells 11 in the case 20 are uniformly cooled or warmed by the fluid flowing through the inner channel.

The inner pipe unit 12 is coupled to an outer pipe unit 30 (hereinafter, as appropriate, referred to as an inlet-side outer pipe unit 30A) via a pipe joint structure 40 on the inlet side (hereinafter, as appropriate, referred to as an inlet-side pipe joint structure 40A), and is coupled to an outer pipe unit 30 (hereinafter, referred to as an outlet-side outer pipe unit 30B) via a pipe joint structure 40 on the outlet side (hereinafter, as appropriate, referred to as an outlet-side pipe joint structure 40B). The fluid circulates in the order of the inlet-side outer pipe unit 30A → a pipe member of the inlet-side pipe joint structure 40A → the inner pipe unit 12 → a pipe member of the outlet-side pipe joint structure 40B → the outlet-side outer pipe unit 30B.

Each pipe joint structure 40 is a structure that connects the inner pipe unit 12 and the outer pipe unit 30. That is, each pipe joint structure 40 is a structure for attaching and fixing the pipe member connected to the inner pipe unit 12 and the pipe member connected to the outer pipe unit 30 to the pipe connection wall body 21A of the case 20. The inlet-side pipe joint structure 40A and the outlet-side pipe joint structure 40B have a common structure, and thus, hereinafter, the configuration of the pipe joint structure 40 will be described in detail as the inlet-side pipe joint structure 40A and the outlet-side pipe joint structure 40B.

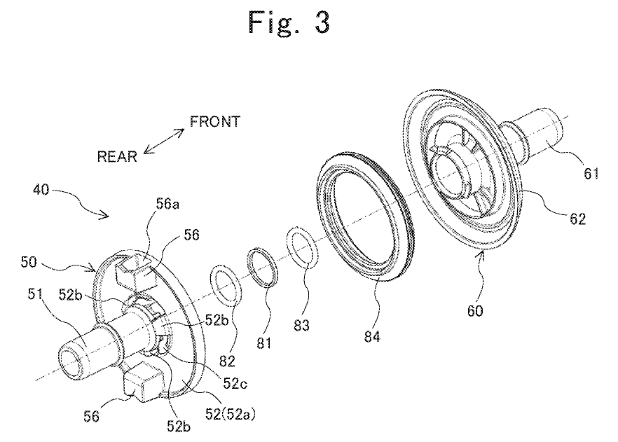

As shown in FIGS. 2 and FIG. 3, the pipe joint structure 40 includes a first pipe member 50, a second pipe member 60, a plate member 70 which is the pipe connection wall body 21A, a spacer 81, O-rings 82, 83, a gasket 84, and a fitting structure 90. The members 50, 60, 70, 81, 82, 83, 84 are formed as separate components. The first pipe member 50 and the second pipe member 60 constitute a pipe joint that connects the inner pipe unit 12 and the outer pipe unit 30. The pipe joint structure 40 is formed such that, first, the first pipe member 50 is assembled to the plate member 70, and then the second pipe member 60 is assembled to the first pipe member 50, whereby the first pipe member 50 and the second pipe member 60 are attached and fixed to the plate member 70.

The first pipe member 50 is a member disposed on the inner side of the case 20 and coupled to the inner pipe unit 12. The first pipe member 50 is assembled to the plate member 70 from the inner side of the case 20. The first pipe member 50 is molded with resin, for example. The material of the first pipe member 50 is a thermoplastic resin such as polyphenylene sulfide (PPS) or polypropylene (PP). As shown in FIGS. 2 and FIG. 9, the first pipe member 50 has a first pipe part 51, a first flange part 52, a claw 53, and a gap 54.

The first pipe part 51 is a hollow-tube-shaped portion through which a fluid flows. The first pipe part 51 is formed in a cylindrical shape, for example. The first pipe part 51 extends in a direction intersecting with the plate member 70 (specifically, the front-rear direction orthogonal to the plate member 70). The first pipe part 51 is formed such that a part or the entirety of the first pipe part 51 has a straight shape in the front-rear direction. The first pipe part 51 is coupled to the second pipe member 60 at the front-side end portion of the first pipe part 51 and coupled to the inner pipe unit 12 at the rear-side end portion of the first pipe part 51.

In the first pipe member 50, the front-side end portion of the first pipe part 51 may be provided at one location, but the rear-side end portion of the first pipe part 51 may be provided at two or more locations when the first pipe part 51 branches into two or more branches.

The first flange part 52 is a plate-shaped portion connected to the outer circumferential surface of the first pipe part 51 and extending radially outward of the first pipe part 51. The first flange part 52 is integrated with the first pipe part 51. The first pipe part 51 and the first flange part 52 are integrated with each other through integral molding of resin, or are integrated with each other by joining and fixing together a component formed as the first pipe part 51 and a component formed as the first flange part 52, for example.

As shown in FIG. 3, the first flange part 52 has a flat plate-shaped flange body 52a and a connection support part 52b connecting the flange body 52a and the first pipe part 51. The flange body 52a is disposed and formed so as to be distant radially outward from the outer circumferential surface of the first pipe part 51 such that a through hole 52c penetrating in the front-rear direction is formed. The connection support part 52b extends so as to connect the circumferential edge end of the through hole 52c in the flange body 52a (i.e., the inner edge end of the flange body 52a) and the outer circumferential surface of the first pipe part 51. A portion to which the connection support part 52b connects in the outer circumferential surface of the first pipe part 51 is positioned on the rear side relative to the position of the flange body 52a in the front-rear direction.

A plurality of the connection support parts 52b (three in the present embodiment) are disposed around the outer circumference of the first pipe part 51 at a predetermined angular interval (120° in the present embodiment) in the whole circumference of the first pipe part 51. Each connection support part 52b has a circumferential width corresponding to an angular distance of 30°, for example. The through hole 52c is provided between the first pipe part 51 and the flange body 52a except for the portions at which the connection support parts 52b are provided, in the whole circumference of the first pipe part 51.

The first flange part 52 may be formed in a circular shape or a quadrate shape. As shown in FIG. 2 and the like, the first flange part 52 is formed in a circular shape, for example. The first flange part 52 (specifically, the flange body 52a) has an opposing surface portion 52d that opposes the rear surface of the plate member 70. The opposing surface portion 52d forms the front surface of the flange body 52a that is directly brought into contact with the rear surface of the plate member 70. The opposing surface portion 52d is formed in a flat plate shape, for example. The first pipe member 50 is disposed such that, on the inner side of the case 20, the first pipe part 51 is inserted into a through hole 71 (described later) of the plate member 70, and the opposing surface portion 52d of the flange body 52a of the first flange part 52 opposes the rear surface of the plate member 70.

The claw 53 is a portion that opposes the front surface of the plate member 70 after the first pipe member 50 is assembled to the plate member 70. When the claw 53 opposes the front surface of the plate member 70, the claw 53 is restricted from moving from the front side to the rear side of the plate member 70, the first pipe member 50 is restricted from moving in either side in the front-rear direction with respect to the plate member 70, and the first pipe member 50 to the plate member 70 are assembled and fixed to each other.

Three or more claws 53 (three in the present embodiment) are provided so as to be spaced from each other around the outer circumference of the first pipe part 51. Each of the claws 53 protrudes radially outward of the first pipe part 51 at a portion located on the front side of the plate member 70 relative to the opposing surface portion 52d of the first flange part 52. In the first pipe member 50 before being assembled to the plate member 70, the rear surface of each of the claws 53 opposes the opposing surface portion 52d.

The gap 54 is a space portion formed between the opposing surface portion 52d of the first flange part 52 and the rear surface of each of the claws 53. The gap 54 has a size (i.e., the distance between the opposing surface portion 52d and the rear surface of the claw 53) S equivalent to the thickness of the plate member 70 (see FIG. 9). Assembling of the first pipe member 50 to the plate member 70 is achieved by the plate member 70 entering the gap 54 and the first pipe member 50 and the plate member 70 engaging with each other.

The claw 53 is provided on the radially outer side relative to the outer circumferential surface of the first pipe part 51. Specifically, the claw 53 is provided at a support part 55 (see FIG. 2) protruding toward the front side from the outer circumferential edge of the through hole 52c, i.e., the inner edge end of the flange body 52a. The claw 53 protrudes radially outward of the first pipe part 51 from the front-side end of the support part 55.

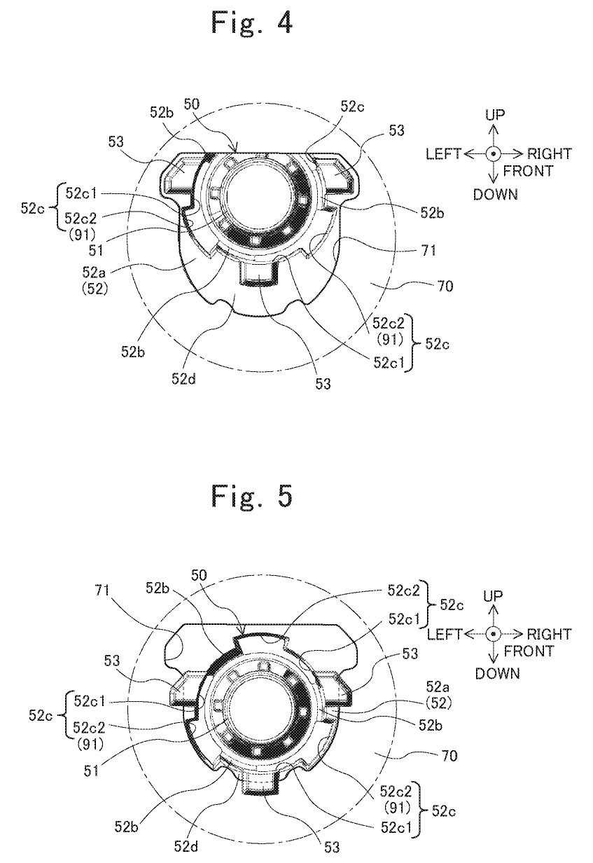

In the first pipe member 50, three claws 53 are provided. The first pipe member 50 is configured such that two claws 53 (the claws 53 on the upper left and upper right sides in FIGS. 4 and FIG. 5) are disposed and formed in line symmetry about an axis (an axis extending in the up-down direction in FIGS. 4 and FIG. 5) passing through the remaining one claw 53 (the claw 53 on the center lower side in FIGS. 4 and FIG. 5). The first pipe member 50 is preferably configured such that the arrangement positions and shape of the three claws 53 are not in point symmetry about the center axis of the first pipe part 51. In addition, the aforementioned axis preferably corresponds to a predetermined direction in which the first pipe member 50 is slidingly moved along the in-plane direction with respect to the front surface and the rear surface of the plate member 70 in a second relationship described later.

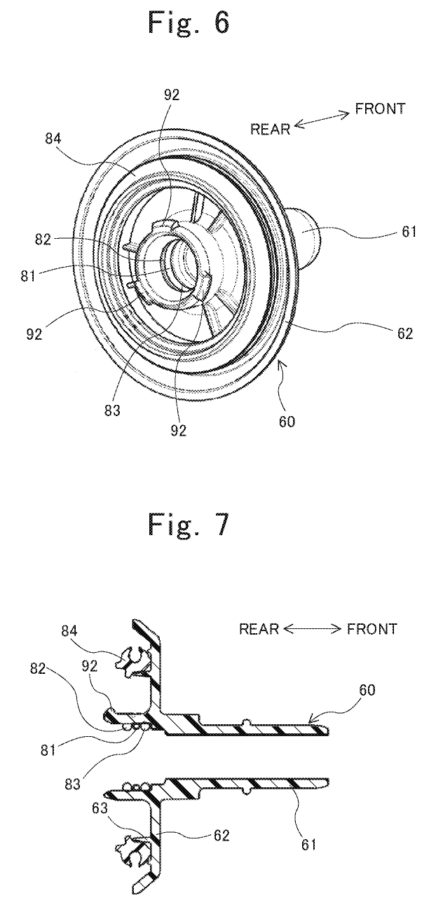

The second pipe member 60 is a member disposed on the outer side of the case 20 and coupled to the outer pipe unit 30. The second pipe member 60 is assembled to the plate member 70 from the outer side of the case 20. The second pipe member 60 is molded with resin, for example. The material of the second pipe member 60 is a thermoplastic resin such as polyphenylene sulfide (PPS) or polypropylene (PP). As shown in FIGS. 2, FIG. 3, FIG. 6, and FIG. 7, the second pipe member 60 has a second pipe part 61 and a second flange part 62.

The second pipe part 61 is a hollow-tube-shaped portion through which a fluid flows. The second pipe part 61 is formed in a cylindrical shape, for example. The second pipe part 61 extends in a direction intersecting with the plate member 70 (specifically, the front-rear direction orthogonal to the plate member 70). The second pipe part 61 is formed such that a part or the entirety of the second pipe part 61 has a straight shape in the front-rear direction. The second pipe part 61 is coupled to the outer pipe unit 30 at the front-side end portion of the second pipe part 61 and coupled to the first pipe member 50 at the rear-side end portion of the second pipe part 61. The rear-side end portion of the second pipe part 61 is disposed on the radially outer side relative to the front-side end portion of the first pipe part 51 and opposes the front-side end portion of the first pipe part 51 in the radial direction. That is, the inner diameter of the rear-side end portion of the second pipe part 61 is larger than the outer diameter of the front-side end portion of the first pipe part 51.

In the second pipe member 60, the rear-side end portion of the second pipe part 61 may be provided at one location, but the front-side end portion of the second pipe part 61 may be provided at two or more locations when the second pipe part 61 branches into two or more branches.

The second flange part 62 is a plate-shaped portion connected to the outer circumferential surface of the second pipe part 61 and extending radially outward of the second pipe part 61. The second flange part 62 is integrated with the second pipe part 61. The second pipe part 61 and the second flange part 62 are integrated with each other through integral molding of resin, or are integrated with each other by joining and fixing together a component formed as the second pipe part 61 and a component formed as the second flange part 62, for example.

The plate member 70 is a member for fixing together the first pipe member 50 and the second pipe member 60. Specifically, the plate member 70 fixes together the first pipe member 50 and the second pipe member 60 by being sandwiched between the first flange part 52 and the second flange part 62 in a state where the first pipe part 51 and the second pipe part 61 are coupled to each other. The plate member 70 is the pipe connection wall body 21A of the case 20 as described above.

The plate member 70 has a through hole 71. The through hole 71 is a hole formed in the front-rear direction for coupling the first pipe part 51 and the second pipe part 61. The through hole 71 is formed in a shape that allows the first pipe part 51 of the first pipe member 50 and the second pipe part 61 of the second pipe member 60 to be inserted.

The through hole 71 is formed in a non-circular shape. Specifically, the through hole 71 allows the three claws 53 to pass therethrough from the rear side to the front side of the plate member 70, and is formed in a line symmetric shape about an axis passing through a portion where one of the claws 53 passes so as to correspond to the arrangement positions and shape of the claws 53 in the first pipe member 50. The through hole 71 is preferably configured such that the arrangement positions and shape of the three claws 53 are not in point symmetry about the center axis of the first pipe part 51.

The first pipe member 50 and the plate member 70 are formed such that structures having (1) first relationship, (2) second relationship, and (3) third relationship, as described below, are established.

### 1. First Relationship

An insertion structure that allows the three claws 53 in the first pipe member 50 to pass through the through hole 71 of the plate member 70 from the rear side to the front side of the plate member 70.

### 2. Second Relationship

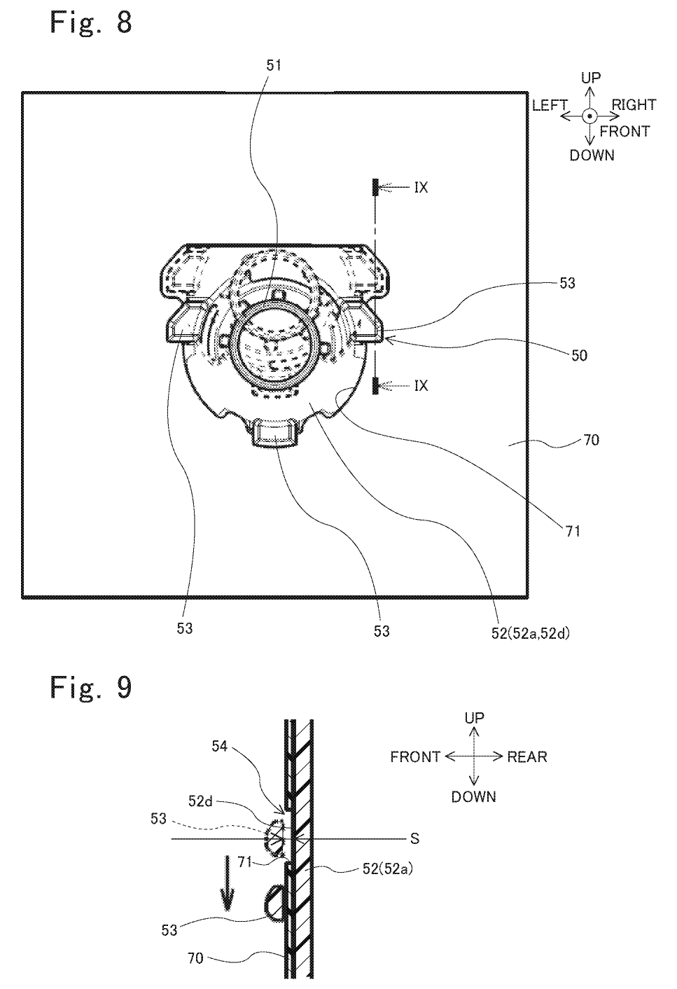

A slide rail structure that allows the first pipe member 50 to slidingly move with respect to the plate member 70 in a predetermined direction (downward in FIGS. 4, FIG. 5, and FIG. 8, in the present embodiment) along the in-plane direction of the front surface and the rear surface of the plate member 70, from a post-passing state where the three claws 53 in the first pipe member 50 are positioned on the front side relative to the plate member 70.

### 3. Third Relationship

A positioning structure that restricts movement of the three claws 53 from the front side to the rear side of the plate member 70 by the three claws 53 opposing the front surface of the plate member 70 in a post-movement state where the first pipe member 50 has been moved with respect to the plate member 70 in the predetermined direction from the post-passing state.
In the third relationship, the claws 53 are restricted from moving from the front side to the rear side of the plate member 70, and simultaneously, the three claws 53 are restricted from moving in the in-plane direction of the plate member 70 other than the predetermined direction in the slide movement.

The spacer 81 is an annular member for ensuring a space between the first pipe part 51 of the first pipe member 50 and the second pipe part 61 of the second pipe member 60. The spacer 81 is sandwiched between the outer circumferential surface of the front-side end portion of the first pipe part 51 and the inner circumferential surface of the rear-side end portion of the second pipe part 61. The spacer 81 is made of metal or resin, for example.

The O-rings 82, 83 are each a seal member sandwiched between the first pipe part 51 and the second pipe part 61 of the second pipe member 60. The O-rings 82, 83 are each formed in an annular shape. The O-rings 82, 83 are made of deformable rubber or resin, for example. The O-ring 82 is disposed adjacent to the spacer 81 on the rear side relative to the spacer 81. The O-ring 82 mainly prevents entry of foreign matter from the outside to the inside of the first pipe part 51 or the second pipe part 61. The O-ring 83 is disposed adjacent to the spacer 81 on the front side relative to the spacer 81. The O-ring 82 mainly prevents leakage of a fluid from the inside to the outside of the first pipe part 51 or the second pipe part 61.

The gasket 84 is a seal member sandwiched between the plate member 70 and the second flange part 62 of the second pipe member 60. The gasket 84 is positioned by a positioning part 63 provided in the second flange part 62. The gasket 84 is formed in an annular shape. The gasket 84 is made of deformable rubber or resin, for example. The gasket 84 comes into contact with the front surface of the plate member 70 in a state of being positioned by the positioning part 63 of the second flange part 62. The gasket 84 prevents entry of foreign matter into the first pipe member 50 side, i.e., the inner side of the case 20, from between the plate member 70 and the second flange part 62 of the second pipe member 60 through the through hole 71 of the plate member 70.

The fitting structure 90 is a structure that causes the second pipe member 60 to fit to the first pipe member 50 from the front side of the plate member 70. Specifically, the fitting structure 90 causes the second pipe member 60 to fit to the first pipe member 50 from the front side of the plate member 70 in a state where the first pipe member 50 is assembled to the plate member 70, i.e., in a restricted state where the three claws 53 oppose the front surface of the plate member 70 and the three claws 53 are restricted from moving from the front side to the rear side of the plate member 70 in the third relationship.

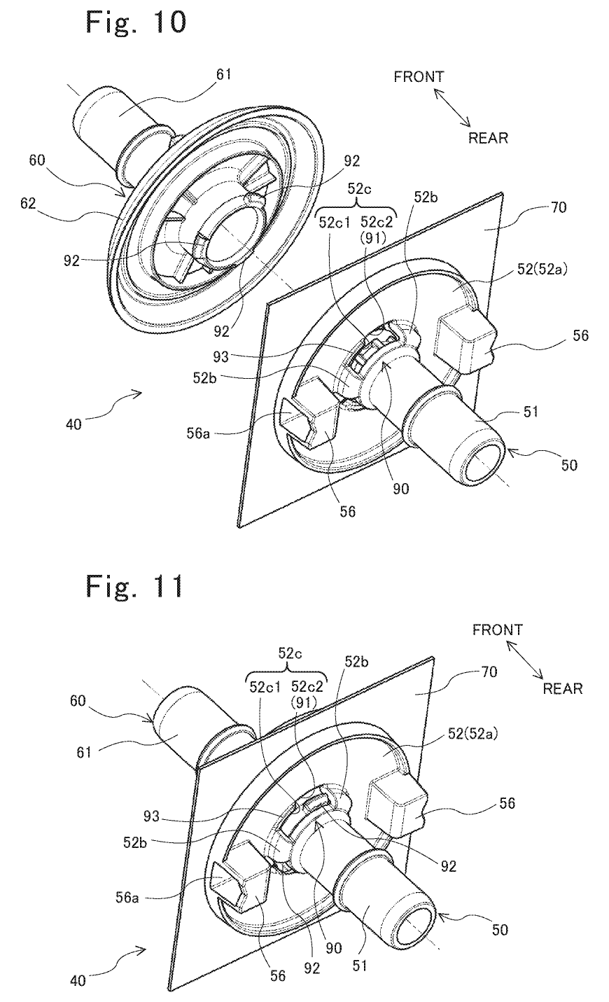

As shown in FIGS. 10 -FIG. 16, the fitting structure 90 has a recess 91, a protrusion 92, and a fitting portion 93. The recess 91 and the protrusion 92 are configured such that the protrusion 92 enters the recess 91 by movement of the second pipe member 60 from the front side of the plate member 70 in the restricted state. In addition, the protrusion 92 and the fitting portion 93 are configured so as to be engaged with each other through relative rotation between the first pipe member 50 and the second pipe member 60 after entry of the protrusion 92 into the recess 91.

The recess 91 is a hole groove portion recessed in the front-rear direction. The recess 91 is provided in the first pipe member 50. In the first flange part 52 of the first pipe member 50, three or more recesses 91 (three in the present embodiment) are provided so as to be spaced from each other around the outer circumference of the first pipe part 51. The recess 91 is a part of the through hole 52c of the first flange part 52.

As shown in FIGS. 4 and FIG. 5, the through hole 52c is formed so as to integrate a narrow part 52c1 having a small radial width around the outer circumference of the first pipe part 51, and a wide part 52c2 having a large radial width around the outer circumference of the first pipe part 51. The narrow part 52c1 has such a radial width that allows the second pipe part 61 (specifically, the tubular wall thereof) of the second pipe member 60 to enter in the front-rear direction. The wide part 52c2 has such a radial width that allows the second pipe part 61 (specifically, the tubular wall thereof) and the protrusion 92 to enter in an integrated manner in the front-rear direction. The narrow part 52c1 and the wide part 52c2 are adjacent to each other in the circumferential direction. The narrow part 52c1 is in contact with the wide part 52c2 at the radially inner side of the wide part 52c2. The recess 91 is the wide part 52c2 of the through hole 52c.

The protrusion 92 is a protruding portion that enters the recess 91. The protrusion 92 is provided in the second pipe member 60. The protrusion 92 protrudes radially outward from the outer circumferential surface of the second pipe part 61 of the second pipe member 60 at the rear-side end of the second pipe part 61 of the second pipe member 60. The protrusion 92 is formed in a shape corresponding to the recess 91 which is the wide part 52c2. Three or more protrusions 92 (three in the present embodiment) are provided so as to be spaced from each other around the outer circumference of the second pipe part 61. The protrusion 92 is formed so as to have a predetermined thickness in the front-rear direction.

The fitting portion 93 is a portion that is engaged with the protrusion 92 in an assembled state where the first pipe member 50 and the second pipe member 60 are assembled to restrict movement of the pipe members 50, 60 in the front-rear direction. The fitting portion 93 is fitted to the protrusion 92 and comes into contact with both the front surface and the rear surface of the protrusion 92 to restrict movement of the pipe members 50, 60 in either side in the front-rear direction.

The fitting portion 93 is provided in the first pipe member 50. The fitting portion 93 is engaged with the protrusion 92 through relative rotation between the first pipe member 50 and the second pipe member 60 after entry of the protrusion 92 into the recess 91. The fitting portion 93 is provided on the radially outer side of the narrow part 52c1 of the through hole 52c. The radial position of the fitting portion 93 corresponds to the radial position of the radially outer side of the wide part 52c2.

The fitting portion 93 is preferably provided at a portion protruding from the rear surface of the first flange part 52 of the first pipe member 50 toward the rear side. This is because such a configuration is, as compared to a configuration in which the fitting portion 93 is provided on the rear surface itself of the first flange part 52, effective in increasing a force for deforming the gasket 84 in the front-rear direction in the assembled state of the first pipe member 50 and the second pipe member 60, and increasing a force applied between the first pipe member 50 and the second pipe member 60 for bringing the first pipe member 50 and the second pipe member 60 into close contact with each other in the front-rear direction.

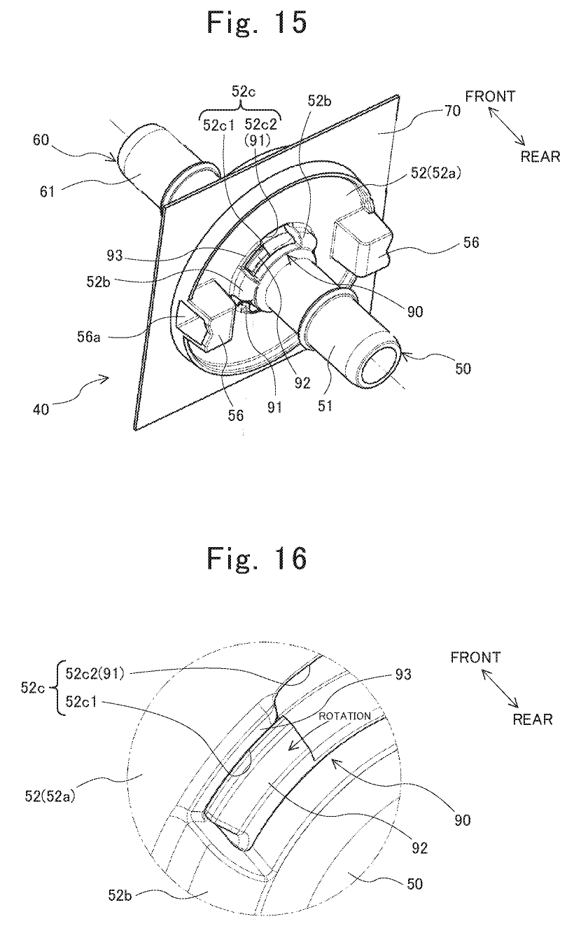

As shown in FIGS. 2, FIG. 3, FIG. 10, FIG. 11, FIG. 13, and FIG. 15, the first flange part 52 of the first pipe member 50 has protruding portions 56. The protruding portions 56 are chuck gripping portions gripped by a worker or an automated robot when assembling the first pipe member 50 to the plate member 70. The protruding portions 56 are provided to protrude from the rear surface of the first flange part 52 toward the rear side. The rear surface of the first flange part 52 is a back surface on the side opposite, in the front-rear direction, to the opposing surface (i.e., the opposing surface portion 52d) at which the first flange part 52 opposes the second flange part 62 in the front-rear direction. The protruding portions 56 may have insertion holes 56a into each of which a jig arm of the automated robot is inserted. In this case, the protruding portions 56 and the insertion holes 56a are suitably provided at two different locations which are 180° apart in the circumferential direction across the first pipe part 51.

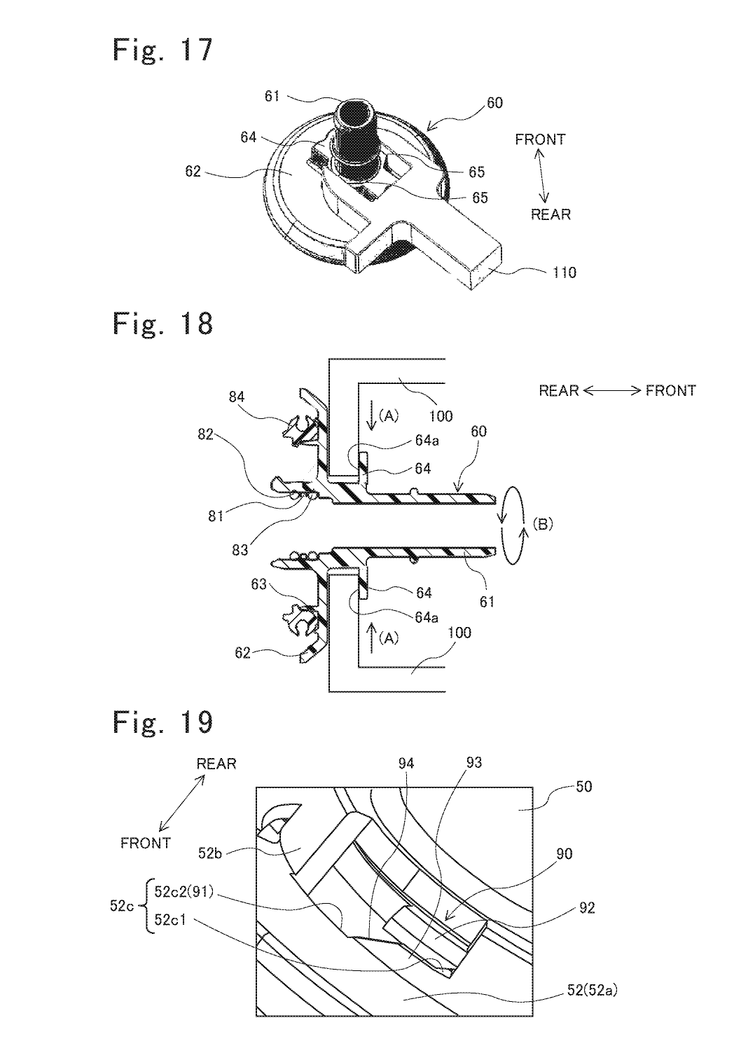

As shown in FIGS. 2, FIG. 17, and FIG. 18, the second flange part 62 of the second pipe member 60 has protruding portions 64, 65. The protruding portions 64, 65 are chuck gripping portions gripped by a worker or an automated robot when assembling the second pipe member 60 to the first pipe member 50 (in particular, when rotating the second pipe member 60 with respect to the first pipe member 50). The protruding portions 64 and the protruding portions 65 are of different types from each other.

The protruding portions 64 are provided to protrude from the front surface of the second flange part 62 toward the front side. The protruding portions 64 have insertion holes 64a into each of which a jig arm 100 of the automated robot is inserted. The protruding portions 64 and the insertion holes 64a are provided at two different locations which are 180° apart in the circumferential direction across the second pipe part 61.

The protruding portions 65 are provided to protrude radially outward from the outer circumferential surface on the base side of the second pipe part 61. The protruding portions 65 may be provided to protrude from the front surface of the second flange part 62 toward the front side. A pair of the protruding portions 65 are provided at locations different from those of the protruding portions 64 in the circumferential direction, and the protruding portions 65 are provided at different locations which are 180° apart in the circumferential direction across the second pipe part 61. The pair of protruding portions 65 have radially outer surfaces extending in parallel to each other across the second pipe part 61. The second pipe member 60 is gripped by the pair of protruding portions 65 being clamped with a wrench 110 toward the center-axis side of the second pipe part 61.

Hereinafter, an assembling procedure for the pipe joint structure 40, i.e., a procedure for attaching the first pipe member 50 and the second pipe member 60 to the plate member 70, will be described.
Assembling of the pipe joint structure 40 is achieved by, first, assembling the first pipe member 50 to the plate member 70, and then assembling the second pipe member 60 to the first pipe member 50.

In assembling of the first pipe member 50 to the plate member 70, first, the first pipe member 50 is disposed on the rear side of the plate member 70, i.e., on the inner side of the case 20, and the first pipe member 50 is moved to the front side in the front-rear direction with respect to the plate member 70 such that the three claws 53 pass through the through hole 71 from the rear side to the front side of the plate member 70 (see FIG. 4).

Next, from a post-passing state where the three claws 53 are positioned on the front side relative to the plate member 70, the first pipe member 50 is slidingly moved with respect to the plate member 70 in a predetermined direction along the in-plane direction of the plate member 70. In a post-movement state where the first pipe member 50 has been moved with respect to the plate member 70 in the predetermined direction along the in-plane direction of the plate member 70 from the post-passing state, the three claws 53 oppose the front surface of the plate member 70 (see FIGS. 5, FIG. 8 and FIG. 9).

In an opposing state where the three claws 53 oppose the front surface of the plate member 70, the three claws 53 are restricted from moving from the front side to the rear side of the plate member 70, and the first pipe member 50 is prevented from being drawn out to the rear side of the plate member 70. Thus, assembling of the first pipe member 50 to the plate member 70 is completed, and the first pipe member 50 and the plate member 70 are integrated with each other.

In assembling of the second pipe member 60 to the first pipe member 50 having been assembled to the plate member 70, first, the second pipe member 60 is disposed on the front side of the plate member 70 (see FIG. 10), and the second pipe member 60 is fitted to the first pipe member 50 from the front side of the plate member 70 by the fitting structure 90.

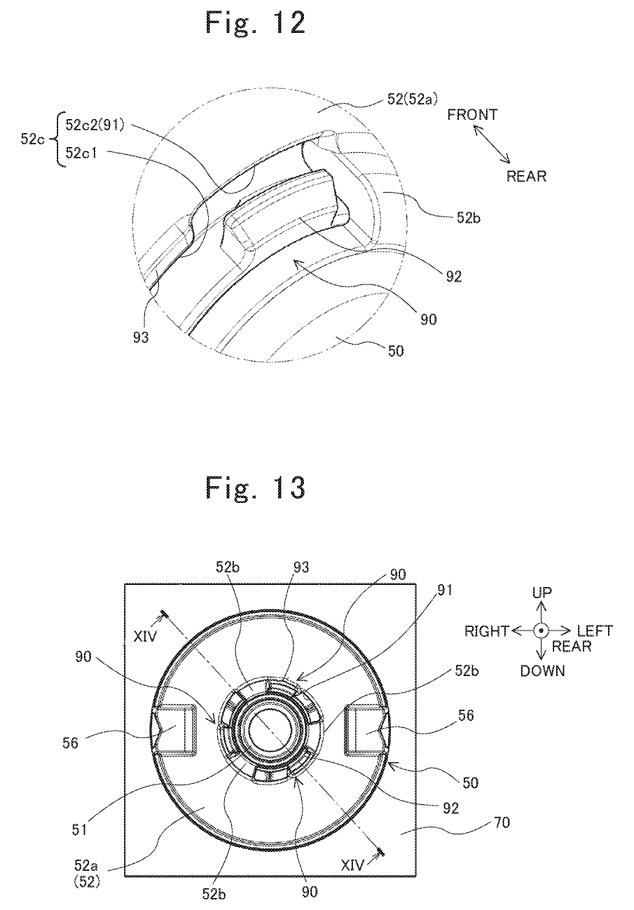

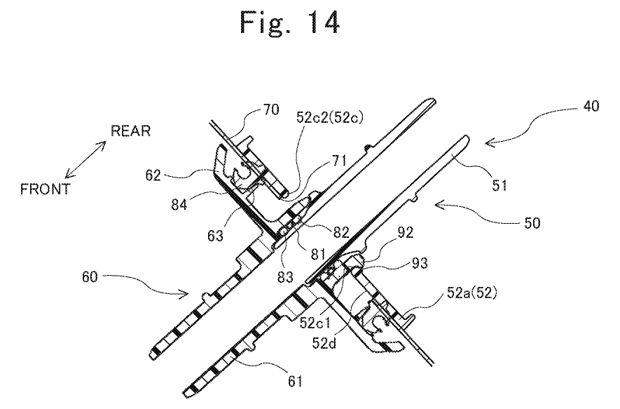

Specifically, first, the second pipe member 60 is moved from the front side to the rear side in the front-rear direction with respect to the plate member 70 such that three protrusions 92 enter three recesses 91 (see FIGS. 11 and FIG. 12). Next, from an entry state where the three protrusions 92 have entered the three recesses 91, the second pipe member 60 is relatively rotated with respect to the first pipe member 50 (rightward rotation with respect to the first pipe member 50 when seen from the front side to the rear side of the plate member 70 in the present embodiment). When such a relative rotation is performed, the protrusions 92 and the fitting portions 93 are engaged with each other (see FIGS. 13 - FIG. 16).

In an engaged state between the protrusions 92 and the fitting portions 93, the first pipe member 50 and the second pipe member 60 are restricted from moving in the front-rear direction, the second pipe member 60 is prevented from being drawn in toward the rear side of the plate member 70, and the second pipe member 60 is prevented from being drawn out toward the front side of the plate member 70. Thus, assembling of the second pipe member 60 to the first pipe member 50 is completed, and the second pipe member 60 is integrated with the first pipe member 50, and furthermore, with the plate member 70.

Accordingly, the pipe joint structure 40 enables the first pipe member 50 and the second pipe member 60 constituting the pipe joint to be assembled to the plate member 70 so as to be attached and fixed. The use of separate components such as bolts and nuts is not needed when achieving assembling of the pipe joint to the plate member 70. Thus, the number of components of the pipe joint structure 40 is reduced, and the assembly man-hours or the manufacturing costs are suppressed. Therefore, assembling of the pipe joint composed of the first pipe member 50 and the second pipe member 60 to the plate member 70 is achieved in a simple manner and at low cost.

If, for example, the second pipe member 60 needs to be replaced due to a failure or the like or the first pipe member 50 needs to be removed from the plate member 70 after the pipe joint structure 40 is assembled, the second pipe member 60 or the first pipe member 50 is removed by reversing the assembling procedure for the pipe joint structure 40.

Specifically, when the second pipe member 60 is required to be removed from the first pipe member 50, and furthermore, from the plate member 70, first, the second pipe member 60 is relatively rotated with respect to the first pipe member 50 in the direction opposite to the direction of rotation at the time of assembling (leftward rotation with respect to the first pipe member 50 when seen from the front side to the rear side of the plate member 70 in the present embodiment), whereby the engagement between the protrusions 92 and the fitting portions 93 is released. Next, the second pipe member 60 is moved with respect to the plate member 70 from the rear side to the front side in the front-rear direction, whereby the three protrusions 92 are drawn out from the three recesses 91 toward the front side of the plate member 70. In this case, the second pipe member 60 is removed from the first pipe member 50 and the plate member 70.

Further, if removal of the first pipe member 50 from the plate member 70 is required, first, from the opposing state where the three claws 53 oppose the front surface of the plate member 70, the first pipe member 50 is moved with respect to the plate member 70 along the in-plane direction of the plate member 70 in a direction different by 180° from the predetermined direction, and the opposing state is released. Then, the first pipe member 50 is moved to the rear side in the front-rear direction with respect to the plate member 70 such that the three claws 53 pass through the through hole 71 from the front side to the rear side of the plate member 70, whereby the three claws 53 are drawn out from the through hole 71 toward the rear side of the plate member 70. In this case, the first pipe member 50 is removed from the plate member 70.

Accordingly, the pipe joint structure 40 enables the first pipe member 50 and the second pipe member 60 to be removed from the plate member 70 and enables the assembled state to be disengaged after assembling of the first pipe member 50 and the second pipe member 60 to the plate member 70. In order to disengage the assembled state, removing separate components such as bolts and nuts one by one is not needed. Therefore, the removal work for the first pipe member 50 and the second pipe member 60 is achieved in a simple manner and at low cost.

In the above-described embodiment, the three claws 53 of the first pipe member 50 are provided around the outer circumference of the first pipe part 51. However, the present disclosure is not limited thereto, and four or more claws 53 of the first pipe member 50 may be provided so as to be spaced from each other around the outer circumference of the first pipe part 51.

In addition, in the above-described embodiment, the first flange part 52 has the protruding portions 56 and the second flange part 62 has the protruding portions 64, 65. However, the present disclosure is not limited thereto, and at least one of the first flange part 52 and the second flange part 62 may have the protruding portions provided to protrude on the back surface on the side opposite, in the front-rear direction, to the opposing surface at which the first and second flange parts 52 and 62 oppose each other.

In addition, in the above-described embodiment, the recess 91 and the fitting portion 93 included in the fitting structure 90 are provided in the first pipe member 50, and the protrusion 92 included in the fitting structure 90 is provided in the second pipe member 60. Further, in the assembling process in which the second pipe member 60 is assembled to the first pipe member 50 having been assembled to the plate member 70, the protrusion 92 enters the recess 91, and then, the first pipe member 50 and the second pipe member 60 are relatively rotated, whereby the protrusion 92 and the fitting portion 93 are engaged with each other. Thus, the first pipe member 50 and the second pipe member 60 are restricted from moving in the front-rear direction.

However, the present disclosure is not limited thereto. As shown in FIG. 19, an inclined portion 94 may be provided between the recess 91 which the protrusion 92 enters and the fitting portion 93 with which the protrusion 92 is engaged in the first pipe member 50 to increase a force for bringing the first pipe member 50 and the second pipe member 60 into close contact with each other in the front-rear direction. The inclined portion 94 is provided between the recess 91 and the fitting portion 93 in the first pipe member 50 to engage with the protrusion 92 in the process of relative rotation between the first pipe member 50 and the second pipe member 60 after the entry of the protrusion 92 into the recess 91. Thus, the force for bringing the first pipe member 50 and the second pipe member 60 into close contact with each other in the front-rear direction is increased. The inclined portion 94 is formed in a tapered shape such that, when the circumferential position of the inclined portion 94 is changed from the recess 91 side to the fitting portion 93 side, the front-rear direction position of the inclined portion 94 is moved to the rear side.

With the configuration of the above-described modification, the force for bringing the first pipe member 50 and the second pipe member 60 into close contact with each other in the front-rear direction is increased in the process of relative rotation between the first pipe member 50 and the second pipe member 60 after the entry of the protrusion 92 into the recess 91. Therefore, workability in terms of bringing the protrusion 92 and the fitting portion 93 into engagement with each other to restrict movement of the first pipe member 50 and the second pipe member 60 in the front-rear direction is improved.

In the above-described embodiment, the fitting structure 90 has the recesses 91 provided in the first pipe member 50, the protrusions 92 provided in the second pipe member 60, and the fitting portions 93 provided in the first pipe member 50. However, the present disclosure is not limited thereto, and the recesses 91 and the fitting portions 93 may be provided in the second pipe member 60 and the protrusions 92 may be provided in the first pipe member 50.

The present disclosure is not limited to the above-described embodiment, etc., and, by, for example, optionally extracting and combining components described in the embodiment, etc., to carry out the present disclosure, various changes may be made without departing from the gist of the present disclosure. In addition, the present specification discloses not only the technical concept according to the citation relationship recited in the claims as originally filed, but also the technical concept obtained by combining the matters recited in the claims as appropriate.

The present application claims priority from Japanese patent application No. 2025-077608 filed on May 7, 2025, the entire contents of which are hereby incorporated by reference.

1. A pipe joint structure comprising:
a first pipe member having a first pipe part through which a fluid flows, and a first flange part connected to an outer circumferential surface of the first pipe part and extending radially outward of the first pipe part;
a second pipe member having a second pipe part which is coupled to the first pipe part and through which the fluid flows, and a second flange part connected to an outer circumferential surface of the second pipe part and extending radially outward of the second pipe part; and
a plate member configured to have a through hole for coupling the first pipe part and the second pipe part to each other, and fix together the first pipe member and the second pipe member by being sandwiched between the first flange part and the second flange part in a state where the first pipe part and the second pipe part are coupled to each other, wherein
the first flange part has an opposing surface portion opposing a rear surface of the plate member,
the first pipe member has a claw protruding radially outward of the first pipe part at a portion located on a front side of the plate member relative to the opposing surface portion,
three or more of the claws are provided so as to be spaced from each other around an outer circumference of the first pipe part,
the first pipe member and the plate member are formed such that
the three or more claws pass through the through hole from a rear side to the front side of the plate member,
the first pipe member is slidingly moved with respect to the plate member in a predetermined direction along an in-plane direction of the plate member, from a post-passing state where the three or more claws are positioned on the front side relative to the plate member, and
the three or more claws oppose a front surface of the plate member in a post-movement state where the first pipe member has been slidingly moved with respect to the plate member in the predetermined direction from the post-passing state to restrict movement of the three or more claws from the front side to the rear side of the plate member, and
the pipe joint structure further comprises a fitting structure configured to fit the second pipe member to the first pipe member from the front side of the plate member in a restricted state where the three or more claws are restricted from moving from the front side to the rear side of the plate member.

2. The pipe joint structure according to claim 1, wherein
the first pipe member has a gap formed between the opposing surface portion of the first flange part and a rear surface of each of the claws, and
the first pipe member and the plate member are engaged with each other through entry of the plate member into the gap.

3. The pipe joint structure according to claim 1, wherein
the fitting structure has:
a recess provided in either one of the first pipe member and the second pipe member;
a protrusion provided in the other of the first pipe member and the second pipe member, the protrusion being configured to enter the recess by movement of the second pipe member from the front side of the plate member in the restricted state; and
a fitting portion provided in the one of the first pipe member and the second pipe member, the fitting portion being configured to be engaged with the protrusion through relative rotation between the first pipe member and the second pipe member after entry of the protrusion into the recess to restrict movement of the first pipe member and the second pipe member in a front-rear direction.

4. The pipe joint structure according to claim 3, wherein the fitting structure has an inclined portion provided between the recess and the fitting portion in the one of the first pipe member and the second pipe member to be engaged with the protrusion in a process of relative rotation between the first pipe member and the second pipe member after entry of the protrusion into the recess, to increase a force for bringing the first pipe member and the second pipe member into close contact with each other in the front-rear direction.

5. The pipe joint structure according to claim 3, wherein at least one of the first flange part and the second flange part has a protruding portion provided to protrude on a back surface on a side opposite, in the front-rear direction, to an opposing surface at which the first flange part and the second flange part oppose each other.

6. The pipe joint structure according to claim 1, wherein
the three claws are provided in the first pipe member, and
the first pipe member is configured such that two of the claws are disposed and formed in line symmetry about a straight line passing through a remaining one of the claws and an axial center of the first pipe part.

7. The pipe joint structure according to claim 6, wherein the through hole allows the three claws to pass therethrough from the rear side to the front side of the plate member, and is formed in a line symmetric shape about a straight line passing through a portion where the one of the claws passes and a portion where the axial center of the first pipe part passes.

8. The pipe joint structure according to claim 1, wherein the plate member is a wall body provided with the through hole in a vehicular housing.

9. An assembling method for the pipe joint structure according to claim 1, the method comprising:
a first step of causing the three or more claws to pass through the through hole from the rear side to the front side of the plate member;
a second step of slidingly moving the first pipe member with respect to the plate member in the predetermined direction from the post-passing state;
a third step of causing the three or more claws to oppose the front surface of the plate member in the post-movement state to restrict movement of the three or more claws from the front side to the rear side of the plate member; and
a fourth step of fitting the second pipe member to the first pipe member from the front side of the plate member by the fitting structure in the restricted state.
